(19) United States
(12) Patent Application Publication
(10) Pub. No.: US 2022/0138377 A1
(43) Pub. Date: May 5, 2022

(54) METHOD FOR VALIDATING SIMULATION MODELS

(71) Applicant: Robert Bosch GmbH, Stuttgart (DE)

(72) Inventors: Johannes Von Keler, Tuebingen (DE); Julian Schmidt, Tuebingen (DE); Michael Baumann, Grafenau (DE); Péter Vass, Budapest (HU)

(21) Appl. No.: 17/452,696

(22) Filed: Oct. 28, 2021

(30) Foreign Application Priority Data
Nov. 4, 2020 (DE) 10 2020 213 892.3

(51) Int. Cl. G06F 30/20

(52) U.S. Cl. CPC G06F 30/20; G06F 2119/02

(57) ABSTRACT

A computer-implemented method for validating simulation data of a simulation model of a technical system. The method includes the following steps: providing a number n of simulation signals for a number N of QOIs (Quantities of Interest), of the simulation model and providing a number m of reference signals for a number N of QOIs of a reference corresponding to the QOIs of the simulation model; determining a particular metric for the N QOIs, determining an overall metric based on the N metrics, at least one metric of the N metrics being taken into consideration in weighted form in the overall metric using a respective weighting coefficient, and determining an overall difference between the n simulation signals and m reference signals, using the Wasserstein metric based on the overall metric.

### CROSS REFERENCE

The present application claims the benefit under 35 U.S.C. § 119 of German Patent Application No. DE 102020213892.3 filed on Nov. 4, 2020, which is expressly incorporated herein by reference in its entirety.

### BACKGROUND INFORMATION

The present invention relates to a computer-implemented method for validating simulation data of a simulation model of a technical system.

Further specific embodiments of the present invention relate to a computer program for carrying out the method.

Further specific embodiments of the present invention relate to the use of the computer-implemented method and/or the computer program for validating a simulation model of a technical system, in particular software, hardware, or an embedded system, in particular in the development of the technical system.

### BACKGROUND INFORMATION

Reference data are typically collected for validating a simulation model at certain points in the parameter space of the simulation model—the so-called validation points. These reference data generally originate from real validation experiments or from simulation runs of a high-accuracy reference model. A so-called model error is calculated at the validation points, a real scalar variable which indicates the deviation between the simulation model and the reference.

For validating scalar signals, for example, a validation framework based on the so-called area validation metric is described, for example, in Oberkampf, William L. and Christopher J. Roy. “Verification and validation in scientific computing.” Cambridge University Press, 2010. Both the simulation results and the reference measurements, which are ideally real experiments, are understood as draws from two different random distributions. That means that an (empirical) distribution function, a cumulative distribution function (CDF) is created both for the simulation and for the reference from the data. These distribution functions are then compared to one another using a metric, for example the area validation metric, for distribution functions. In the area validation metric, the area between the two distribution functions is used as a measure of the non-correspondence of the two distributions.

However, the conventional area validation metric already reaches its limits in the rather simple case in which the recorded signals are points in the plane. In the conventional validation framework, there is no option for statistically comparing simulation and reference. If multiple data points, in the best case even very many data points, have been recorded in each case for simulation and reference, up to this point there has been no option for comparing the two data sets as a whole and calculating an objective value of the non-correspondence. Furthermore, the conventional area validation metric may not be readily expanded to multidimensional signals. On the one hand, the expansion to a hypervolume validation metric is not readily possible since the volume which is enclosed by two measurements is already infinitely large. Furthermore, correlations between two signals are completely unconsidered in the case of simple adding together of individual metric results. This is problematic in particular in the case of highly correlated outputs such as the individual points in time of a time series.

Furthermore, a method is described in Oberkampf, William L. and Christopher J. Roy. “Verifikation und Validierung im wissenschaftlichen Rechnen” [Verification and validation in scientific computing]. Cambridge University Press, 2010, and Oberkampf, William L., and Christopher J. Roy. “Ein umfassender Rahmen für Verifikation, Validierung und Unsicherheitsquantifizierung im wissenschaftlichen Rechnen.” Computermethoden in der angewandten Mechanik und im Ingenieurwesen [A comprehensive framework for verification, validation, and uncertainty quantification in scientific computing. Computer methods in applied mechanics and in engineering], 200(25-28), 2131-2144. 2011, which enables the pieces of information of various variables to be observed to be combined to form an overall result. The so-called U-pooling method uses the distribution of the reference to transform the simulation results into so-called u values, which are between zero and one. The more similar reference and simulation are, the more it is expected that the U values are uniformly distributed on [0, 1]. Since after this procedure all variables to be considered are transformed into U values on the unit interval, these may be summarized to form a single distribution of the U values for the simulation or the reference. The difference between simulation and reference may subsequently be calculated using the area validation metric for the u distributions.

However, the conventional methods do not permit a correlation between various observed simulation outputs to also be incorporated into the overall assessment of the simulation model.

The present invention is therefore based on the object of overcoming the disadvantages in the related art.

### SUMMARY

One embodiment of the present invention relates to a computer-implemented method for validating simulation data of a simulation model of a technical system. In accordance with an example embodiment of present invention, the method includes the following steps:

providing, for a number N of QOIs (Quantities of Interest), of the simulation model, a number n of simulation signals including the N QOIs and providing, for a number N of QOIs of a reference corresponding to the QOIs of the simulation model, a number m of reference signals including the N QOIs;

determining a particular metric for the N QOIs, determining an overall metric based on the N metrics, at least one metric of the N metrics being taken into consideration in weighted form in the overall metric with a particular weighting coefficient, and determining an overall difference between the n simulation signals and m reference signals, using the p Wasserstein metric based on the overall metric.

QOIs (Quantities of Interest), are, for example, output variables of the simulation model to be observed. The output variables of the simulation model are compared to output variables from the reference using the method according to the present invention.

The simulation signals and/or the reference signals include, for example, scalar signals and/or multidimensional signals, in particular two-dimensional or multidimensional vectors and/or correlated signals and/or time series signals. Two-dimensional or multidimensional vectors are used, for example, when a spatial orientation is described. Correlated signals are used, for example, to combine multiple outputs of a model in order to represent the correlation of the outputs. In the case of time series signals, each point in time at which a signal is recorded is viewed as an individual signal.

A particular QOI of the simulation model may differ in a characteristic of the QOI from a particular other QOI. A particular QOI of the reference accordingly also differs in a characteristic of the QOI from a particular other QOI.

To take into consideration number N of QOIs, which at least partially differ from one another in their characteristic, jointly in the overall metric, a weighted consideration is proposed.

According to one specific embodiment of the present invention, it is provided that the method furthermore includes a step for determining a particular weighting coefficient as a function of a characteristic of a particular QOI, in particular a characteristic of the simulation signals of the particular QOI. It may similarly also be provided that a particular weighting coefficient is determined as a function of a characteristic of a particular QOI of the reference. Advantageously, in this way the characteristic of the QOI of the simulation model or the corresponding QOI of the reference is taken into consideration in the overall metric.

According to one specific embodiment of the present invention, it is provided that for a number L, in particular a number N of the N metrics, a particular weighting coefficient is determined to be 1/L, in particular 1/N. This selection of the weighting coefficients is particularly well suitable for time series signals having a number of time steps recorded at L, or a number of time steps recorded at N.

According to one specific embodiment of the present invention, it may prove to be advantageous for the particular weighting coefficients to add up to 1.

According to one specific embodiment of the present invention, it is provided that at least one weighting coefficient takes into consideration a scaling-dependent weighting. Different scales, on which particular QOIs of the simulation model and/or corresponding QOIs of the reference vary, are advantageously thus taken into consideration in the overall metric. If, for example, one QOI of the simulation model varies on a greater scale than another QOI of the simulation model, the value of the metric for this QOI is thus greater in comparison to the value of the metric of the other QOI. The absolute value of the overall metric which is based on the QOI having the greater scale would thus possibly dominate in the overall metric and thus possibly distort the result and decisions based on the result. This may be prevented using the scale-based weighting.

According to one specific embodiment of the present invention, it is provided that a particular weighting coefficient is individually determined. In this way, model-dependent characteristics and/or expert knowledge about a particular simulation data set and/or reference data set may advantageously be taken into consideration.

According to one specific embodiment of the present invention, it is provided that at least one weighting coefficient includes multiple partial coefficients. Various types of weighting may advantageously be taken into consideration in the weighting coefficient by way of the partial coefficients. For example, a scaling-dependent weighting having an individual weighting based, for example, on expert knowledge may be taken into consideration.

Further specific embodiments of the present invention relate to a computer program for validating data of a simulation model, the computer program including computer-readable instructions, upon the execution of which by a computer, a computer-implemented method according to the specific embodiments is carried out.

Further specific embodiments of the present invention relate to the use of a computer-implemented method according to the specific embodiments and/or a computer program according to the specific embodiments for validating a simulation model of a technical system, in particular software, hardware, or an embedded system, in particular in the development of the technical system.

Further features, possible applications, and advantages of the present invention result from the following description of exemplary embodiments of the present invention which are shown in the figures. All features described or shown form the subject matter of the present invention as such or in any arbitrary combination, regardless of their wording or depiction in the description or in the figures.

### BRIEF DESCRIPTION OF THE DRAWINGS

FIG. 1 shows steps of a computer-implemented method in a schematic representation in a flowchart, in accordance with an example embodiment of the present invention.

FIG. 2 shows aspects of a computer-implemented method in a schematic representation, in accordance with an example embodiment of the present invention.

FIG. 3 shows aspects of a use of the computer-implemented method from FIG. 1 in a schematic representation, in accordance with an example embodiment of the present invention.

### DETAILED DESCRIPTION OF EXAMPLE EMBODIMENTS

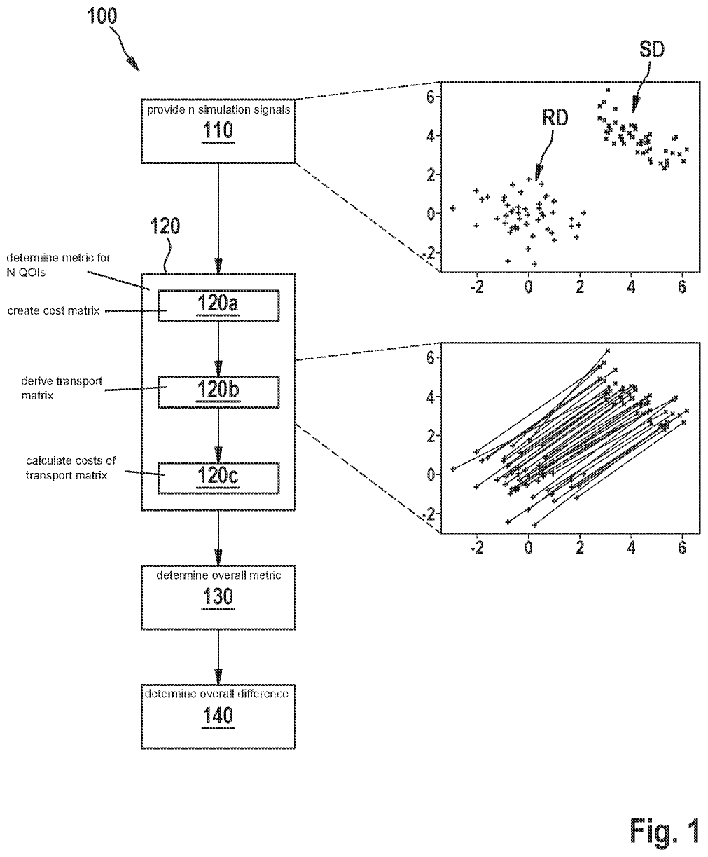

Schematic steps of a computer-implemented method 100 for validating simulation data of a simulation model of a technical system are shown in FIG. 1.

Method 100 includes a step 110 for providing a number n of simulation signals for a number N of QOIs (Quantities of Interest), and providing a number m of reference signals for a number N of QOIs corresponding to the QOIs of the simulation model.

According to the illustrated specific embodiment of the present invention, for each QOI of the simulation model, a simulation data set SD including a number n of simulation signals is provided. For each QOI of the reference, a reference data set RD including a number m of reference signals is provided.

According to the illustrated specific embodiment of the present invention, a particular simulation data set includes a number n of simulation signals with n>1. A particular reference data set includes a number m of reference signals with m>1. Number n of the simulation signals and/or number m of the reference signals may be of different amounts for various simulation data sets and/or reference data sets.

The simulation signals of the simulation data sets and/or the reference signals of the reference data sets include, for example, scalar signals and/or multidimensional signals, in particular two-dimensional or multidimensional vectors and/or correlated signals and/or time series signals. Two-dimensional or multidimensional vectors are used, for example, when a spatial orientation is described. Correlated signals are used, for example, to combine multiple outputs of a model in order to represent the correlation of the outputs. In time series signals, each point in time at which a signal is recorded is viewed as an individual signal of a data set.

According to the illustrated specific embodiment of the present invention, a particular simulation data set is modeled as a random distribution including the number of n simulation signals. The reference data sets are also given by a random distribution including number m of reference signals. The reference signals originate, for example, from real measurements or from a reference model and therefore typically have a natural variability. For example, various parameters may vary during various passes of a measurement. Independently of how well one attempts to control all parameters of a measurement, some of them will vary during each pass of the measurement. If one presumes a deterministic simulation model, the simulation would always supply the same result at fixed parameters. The experiment is therefore newly modeled in the simulation in that some of the parameters are randomly varied and the results are recorded. If these parameters, which are referred to as aleatoric parameters, are distributed in the correct way, the particular simulation data set will be very similar to the particular corresponding reference data set if the simulation model correctly reproduces the relevant effects.

Method 100 furthermore includes a step 120 for determining a particular metric for the N QOIs of the simulation model and the N QOIs of the reference.

A particular QOI of the simulation model may differ in a characteristic of the QOI from a particular other QOI. Correspondingly, a particular QOI of the reference also differs in a characteristic of the QOI from a particular other QOI. To take into consideration number N of QOIs, which at least partially differ from one another in their characteristic, jointly in the overall metric, a weighted consideration is provided.

The method furthermore includes a step 130 for determining an overall metric based on the N metrics, at least one metric of the N metrics being taken into consideration in weighted form in the overall metric using a particular weighting coefficient.

The method furthermore includes a step 140 for determining an overall difference between the n simulation signals and m reference signals using the p Wasserstein metric based on the overall metric.

According to the illustrated specific embodiment, method 100 furthermore includes a step for determining a particular weighting coefficient as a function of a characteristic of a particular QOI of the simulation model. Alternatively, it may also be provided that a particular weighting coefficient is determined as a function of a characteristic of a particular QOI of the reference. In this way, the characteristic of the QOI of the simulation model or the corresponding QOI of the reference is advantageously taken into consideration in the overall metric.

Mathematically, the method may be described as follows: n is the number of the simulation signals of a simulation data set and m is the number of the reference signals of a reference data set, N is the number of the QOIs, and therefore also the number of the simulation data sets, and the number of the reference data sets corresponding to the simulation data sets, each QOI of the simulation model and each QOI of the reference assuming values in [symbol] ^{k}^{ᵢ}. A distance function on these spaces is given by dᵢ. The vector of all QOIs assumes values in the product space [symbol] ^{k}, with k:=Σᵢkᵢ. This product space is then provided with a distance function which is related to individual metrics dᵢ. The distance function is specifically defined as d:=(Σᵢαᵢdᵢ^{q})^{1/q} with αᵢ>0 and q≥1, αᵢ being a particular weighting coefficient and q being the weighted Hölder mean.

In summary, the product from metric spaces may be defined via:

⊗ᵢ₌₁^{N}( [symbol] ^{k}^{ᵢ},d₁)=( [symbol] ^{k},d).

For each p≥1, for the p-th Wasserstein distance between a first probability distribution representing a particular QOI of the simulation model including simulation signals {xⱼ}_{1≤j≤n} of the particular simulation data set and a second probability distribution representing a particular QOI of the reference including reference signals {yᵢ}_{1≤i≤m} of the particular reference data set

$${p}_{p}^{} ( \{ {x}_{i} \} , \{ {y}_{i} \} ) := {min}_{M} {\sum }_{i} {\sum }_{j} {M}_{i j} {d ( {x}_{j} , {y}_{i} )}^{p}$$

M is in this case a so-called transport matrix which meets certain conditions. The calculation of the transport matrix is carried out as follows, for example:

Determination 120 of a metric between a first probability distribution including simulation data SD and a second probability distribution including reference data RD using the p Wasserstein metric includes the following steps:

a step 120a for creating a cost matrix based on the simulation signals and the reference signals, a step 120b for deriving a transport matrix based on the cost matrix, and a step 120c for calculating costs of the transport matrix using the p Wasserstein metric.

The cost matrix is, according to the illustrated specific embodiment, m×n or n×m matrix. Creation 120a of the cost matrix includes the calculation of the distance of a particular simulation signal to a particular reference signal. Each simulation signal is compared to each reference signal. The i-j-th entry of the matrix is the distance of the i-th simulation signal from the j-th reference signal, with 1≤i≤n and 1≤j m. The overall metric is used as the distance measure to calculate the distance.

Derivation 120b of a transport matrix based on the cost matrix is carried out, for example, using a solution algorithm based on the so-called “Hungarian method.” The transport matrix is also a matrix of equal dimension as the cost matrix in the case of empirical data.

Calculation 120c of costs of the transport matrix takes place using the p Wasserstein metric. The cost of the transport matrix is the desired p Wasserstein distance between the first probability distribution including simulation data SD and the second probability distribution including reference data RD.

Algorithms for derivation 120c of the transport matrix and for calculation 120c of costs of the transport matrix are described, for example, in https://pythonot.github.io/auto_examples/plot_OT_2D_samples. html#sphx-glr-auto-examples-plot-of-2d-samples-py.

Each xⱼ and yᵢ is in this case a N vector which is compounded of all individual values of the QOIs, for example, xⱼ=(xⱼ¹, xⱼ², . . . , xⱼ^{N}).

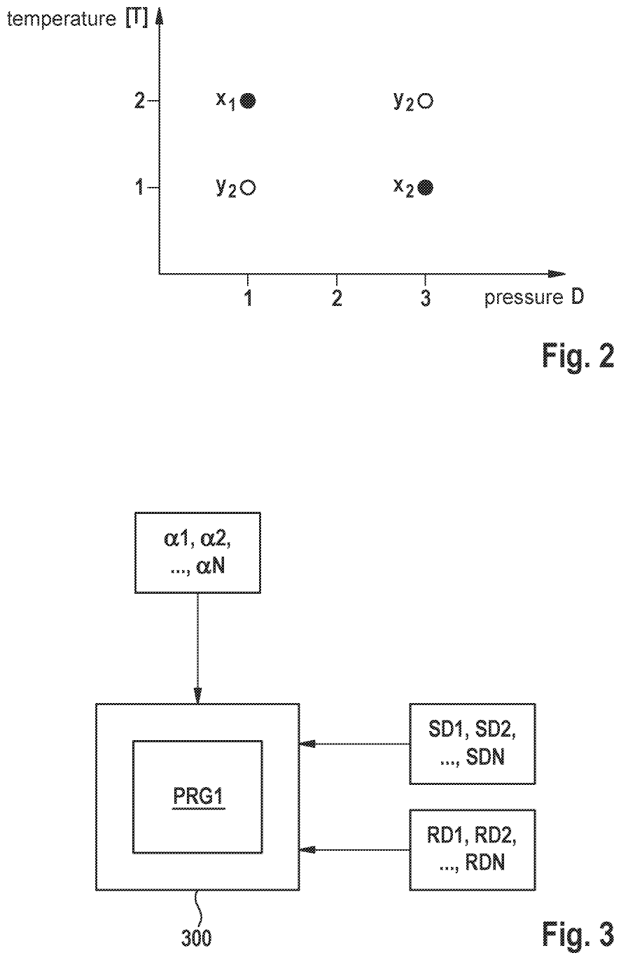

Aspects of the method are explained hereinafter with reference to FIG. 2, FIG. 2 showing aspects of a computer-implemented method in a schematic representation.

Greatly simplified results of two passes of a validation experiment, in which pressure D and temperature T of a gas are measured, for example, are shown in FIG. 2. The measured reference data of the first pass are yᵢ=(y₁^{D},y₁^{T})=(1, 1), the measured reference data of the second pass are y₂=(y₂^{D},y₂^{T})=(3,2).

The corresponding simulation data which were generated using the simulation model to simulate the validation experiment are, according to the illustrated specific embodiment x₁=(x₁^{D},x₁^{T})=(1,2), and x₂=(x₂^{D},x₂^{T})=(3, 1).

In the following, initially an application of the approach from the related art, applying the area validation metric separately to the individual signals of the simulation and reference data sets, is explained by way of example. The area validation metric for reference and simulation data y1, x1 from the first pass and the area validation metric for reference and simulation data y2, x2 from the second pass add up to zero both for the values of the pressure and for the values of the temperature. Both for the pressure and for the temperature, the difference between the simulation distribution and the reference distribution disappears completely upon calculation of the area validation metric. This is the case if the reference distribution is equal to the simulation distribution. In the calculation of the area validation metric, the labeling of the coordinates of the signals, whether it is signal one from the first pass or signal two from the second pass, does not play a role for the distribution. If one takes this into consideration in FIG. 2, it is clear why the area validation metric does not differ in this case between simulation and reference. The result of the area validation metric obviously contradicts the simulation and reference data. Upon viewing the signals in FIG. 2 in the D-T plane, it is clear that the distributions of simulation signals and reference signals are different. Furthermore, the reference signals indicate a positive correlation between pressure and temperature, whereas the simulation signals suggest the contrary. The positive correlation typically applies for gases. The area validation metric is not capable in the example shown of recognizing this error in the simulation data. The application of the area validation metric separately to the individual signals of the simulation and reference data sets is therefore unsuitable in this case.

Furthermore, an application of the approach from the related art of the U-pooling method is explained hereinafter by way of example. As already explained in the preceding paragraph, the pressure distributions and the temperature distributions of simulation data and reference data are identical, neglecting the observation of which signals originate from the first pass and which from the second pass. Upon application of the transformation induced by the reference to generate the u values, the result is the same for both variables, temperature and pressure, and both for the reference data and for the simulation data. The values u₁=½ and u₂=1 result. The U-pooling method does transform the various scales successfully into a universal scale, but the combination of the values also does not result in a solution, because an addition of the values u₃=½ and u₄=1 does not change the corresponding distribution, however.

In the following, the application of method 100 to the example shown in FIG. 2 is explained. For simplified observation, initially p=q=1 and α₁=α₂=1 are selected. It follows therefrom that the product metric is given by d(x,y):=|y^{D}−x^{D}|+|y^{T}−x^{T}|. Upon use of this metric, all points xᵢ, yᵢ have a positive distance from one another, for example, d(x₁, y₂)=2. It follows therefrom that the Wasserstein distance on the product space using this metric is also not equal to zero. For the 1 Wasserstein distance, for example, W₁({xⱼ}, {yᵢ})=1 results. Method 100 thus permits discrepancies between reference data and simulation data to be indicated, whereas the conventional methods of the area validation metric and also the U-pooling method have not supplied a reliable result with these data.

In the following, the selection of weighting coefficients αᵢ is explained. In principle, the selection of weighting coefficients αᵢ may be carried out at least partially in automated form. The selection of weighting coefficients αᵢ is, however, an important technical decision and may have a significant influence on the result of the model validation. This is clear, for example, if one observes the situation of the model selection in which it is possible to select between different variants of a simulation model. In this case, a different reactive weighting of the individual features of a simulation model may result in different optimal model configurations. Different approaches for selecting the coefficients are explained hereinafter. In addition, an additional relative weighting may advantageously be incorporated between on the basis of model requirements and/or expert knowledge, in particular manually.

According to one specific embodiment of the present invention, it is provided that for a number L, in particular a number N of the N metrics, a particular weighting coefficient αᵢ is determined to be 1/L, in particular to be 1/N. This selection of weighting coefficients αᵢ is particularly well suitable for time series signals having a number of L, or a number of N, recorded time steps. For number L or N of time steps, the metrics for L or N converges toward infinity in the integral q norm. For q=2 and dᵢ=|·|, resulting metric d is the so-called root mean square error, RMSE.

According to one specific embodiment of the present invention, it may prove to be advantageous that particular weighting coefficients αᵢ add up to 1. For a second factor, which is only a copy of a first factor, thus, for example if the following applies: d=d₁=d₂ and x=x₁=x₂ and y=y₁=y₂, the following is to apply

(a₁d₁^{q}+α₂d₂^{q})((x₁,x₂),(y₁,y₂))=d^{q}(x,y).

This relationship may only be achieved if weighting coefficients αᵢ add up to one. Advantageously, upon a selection of weighting coefficients αᵢ to be 1/L, or to be 1/N, for L or N weighting coefficients α, these advantageously also add up to one.

A further advantage of this selection of weighting coefficients αᵢ results from the following inequality under the assumption p=q. The following then applies:

$${p}_{p}^{} ( \{ {x}_{i} \} , \{ {y}_{i} \} ) := {min}_{M} {\sum }_{i} {\sum }_{j} {M}_{ij} {d ( {x}_{j} , {y}_{i} )}^{p} = {min}_{M} {\sum }_{i} {\sum }_{j} {M}_{ij} ( {α}_{1} {{d}_{1} ( {x}_{j}^{1} , {y}_{i}^{1} )}^{p} + {α}_{2} {{d}_{2} ( {x}_{j}^{2} , {y}_{i}^{2} )}^{p} ) \geq {α}_{1} {min}_{M} {\sum }_{i} {\sum }_{j} {M}_{ij} {{d}_{1} ( {x}_{j}^{1} , {y}_{i}^{1} )}^{p} + {α}_{2} {min}_{\tilde{M}} {\sum }_{i} {\sum }_{j} {\tilde{M}}_{ij} {{d}_{2} ( {x}_{j}^{2} , {y}_{i}^{2} )}^{p} ) = {α}_{1} {W}_{p}^{p} ( \{ {x}_{j}^{1} \} , \{ {y}_{i}^{1} \} ) + {α}_{2} {W}_{p}^{p} ( \{ {x}_{j}^{2} \} , \{ {y}_{i}^{2} \} )$$

Under the assumption that weighting coefficients αᵢ, in this case α₁ and α₂, add up to one, it is shown for the above inequality that the weighted p-th power mean value (see [Wik20b]) of the individual Wasserstein distances represents a lower limit for overall metric [symbol] ₚ^{p}({xᵢ},{yᵢ}). The remaining difference, the greater overall metric, may be attributed to the considered correlations between the observed QOIs. For p=2, it is described, for example, from Panaretos, V. M. and Zemel, Y. “Statistische Aspekte der Wasserstein-Distanzen” [Statistical aspects of the Wasserstein distances]. Jährlicher Überblick über die Statistik and ihre Anwendung [Annual overview of statistics and their application] 6, 405-431, 2019, that independent measurements result in identity of the above inequality.

According to one specific embodiment of the present invention, it is provided that at least one weighting coefficient αᵢ takes into consideration a scaling-dependent weighting. Different scales, on which particular QOIs of the simulation model and/or corresponding QOIs of the reference vary, are thus taken into consideration in the overall metric. For example, if one QOI varies on a greater scale than another QOI, the value of the metric for this QOI is greater in comparison to the value of the metric of the other QOI and would thus dominate in the overall metric. This may be prevented using the scale-based weighting. The scaling-dependent weighting may be calculated, for example, in the following way: Initially, all simulation signals of a simulation data set {x₁} and also all reference signals of a reference data set {y₁} are compiled to obtain n+m signals {zₗ¹}_{1≤l≤n+m}. Furthermore, empirical standard deviation s¹ of the z¹ values is calculated. For k₁>1, this is given by curve s¹=\sqrt{tr(Σ¹)}. Weighting coefficient α₁ is given in this case by 1/s₁. The calculation of the scaling-dependent weighting may advantageously be repeated for all N QOIs.

According to one specific embodiment, it is provided that a particular weighting coefficient αᵢ is individually determined. In this way, model-dependent characteristics and/or expert knowledge about a particular QOI of the simulation model and/or QOI of the reference may advantageously be taken into consideration.

According to one specific embodiment, it is provided that at least one weighting coefficient αᵢ includes multiple partial coefficients. Different types of weighting may advantageously be taken into consideration in weighting coefficient αᵢ by way of the partial coefficients. For example, a scaling-dependent weighting may be taken into consideration with an individual weighting based on expert knowledge, for example.

Further specific embodiments relate to the use of method 100 and/or a computer program PRG1 for validating a simulation model of a technical system, in particular software, hardware, or an embedded system, in particular in the development of the technical system.

FIG. 3 shows a use of method 100 or of computer program PRG1 in the validation framework.

By carrying out method 100, in particular by executing computer program PRG1 on a processing unit 300, the simulation model is validated.

Initially, a number N of simulation data sets SD including a number of simulation signals and a number N of reference data sets RD corresponding to the simulation data sets including a number of reference signals are provided.

Furthermore, weighting coefficients αᵢ are provided as a function of a characteristic of the QOIs for simulation data sets and reference data sets.

A particular metric for the N simulation data sets and the N reference data sets is then determined by carrying out method 100, in particular by executing computer program PRG1 on processing unit 300. Furthermore, an overall metric based on the N metrics, at least one metric of the N metrics being taken into consideration in weighted form in the overall metric using a particular weighting coefficient αᵢ, is determined. Furthermore, an overall difference between the n simulation signals and m reference signals is determined using the p Wasserstein metric based on the overall metric.

Further specific embodiments relate to a use of a computer-implemented method according to the specific embodiments and/or a computer program according to the specific embodiments for validating a simulation model of a technical system, in particular software, hardware, or an embedded system, in particular in the development of the technical system.

The simulation model is, for example, an HiL, Hardware in the Loop, or an SiL, Software in the Loop, simulation model. The simulation model is used in this case as a simulation of the real surroundings of the technical system. HiL and SiL are methods for testing hardware and embedded systems or software, for example, for assistance during the development and for early startup. A simulation-based release may be assisted, for example, with the use of method 100 for validating a simulation model of a technical system, in particular software, hardware, or an embedded system, in particular in the development of the technical system. Furthermore, an improved simulation model for the development and/or validation of the technical system, and thus advantageously further positive effects, such as increased security, may be provided by using method 100.

The technical system may be, for example, software, hardware, or an embedded system. The technical system is in particular a technical system, for example, a control unit or software for a control unit, for a motor vehicle, in particular for an autonomous or semiautonomous motor vehicle. In particular, it may also be a safety-relevant technical system.

In particular in the automotive field, simulation models often include multidimensional signals. Two-dimensional or multidimensional vectors are used, for example, to describe the orientation of a motor vehicle. Furthermore, correlated signals are used if the simulation model has multiple outputs, for example, temperature, pressure, and velocity, and these signals are generally not independent of one another. Moreover, time series signals may be used if a chronological component of signals is to be taken into consideration.

What is claimed is:

1. A computer-implemented method for validating simulation data of a simulation model of a technical system, the method comprising the following steps:
providing a number n of simulation signals for a number N of QOIs (Quantities of Interest), of the simulation model and providing a number m of reference signals for a number N of QOIs of a reference corresponding to the QOIs of the simulation model;
determining a respective metric for each of the N QOIs;
determining an overall metric based on the N respective metrics, at least one metric of the N respective metrics being taken into consideration in weighted form in the overall metric using a respective weighting coefficient; and
determining an overall difference between the n simulation signals and m reference signals, using a Wasserstein metric based on the overall metric.

2. The computer-implemented method as recited in claim 1, further comprising:
determining each respective weighting coefficient as a function of a characteristic of the simulation signals of a respective one of the QOIs of the simulation model.

3. The computer-implemented method as recited in claim 1, wherein for each of a number N of the N respective metrics, the respective weighting coefficient is determined to be 1/N.

4. The computer-implemented method as recited in claim 1, wherein each respective weighting coefficient is individually determined.

5. The computer-implemented method as recited in claim 1, wherein the respective weighting coefficients add up to 1.

6. The computer-implemented method as recited in claim 1, wherein at least one respective weighting coefficient takes into consideration a scaling-dependent weighting.

7. The computer-implemented method as recited in claim 1, wherein at least one respective weighting coefficient includes multiple partial coefficients.

8. The computer-implemented method as recited in claim 1, wherein simulation signals and/or reference signals include scalar signals and/or multidimensional signals vectors and/or correlated signals and/or time series signals.

9. A non-transitory computer-readable storage medium on which is stored a computer program including computer-readable instructions for validating simulation data of a simulation model of a technical system, the computer-readable instructions, when executed by a computer, causing the computer to perform the following steps:
providing a number n of simulation signals for a number N of QOIs (Quantities of Interest), of the simulation model and providing a number m of reference signals for a number N of QOIs of a reference corresponding to the QOIs of the simulation model;
determining a respective metric for each of the N QOIs;
determining an overall metric based on the N respective metrics, at least one metric of the N respective metrics being taken into consideration in weighted form in the overall metric using a respective weighting coefficient; and
determining an overall difference between the n simulation signals and m reference signals, using a Wasserstein metric based on the overall metric.

10. The method as recited in claim 1, wherein the technical system is software, or hardware, or an embedded system.
